(19) United States
(12) Patent Application Publication
(10) Pub. No.: US 2008/0113137 A1
(43) Pub. Date: May 15, 2008

(54) Inner tube of balls

(75) Inventor: Andrew Wang, Taipei (TW)

Correspondence Address: BIRCH STEWART KOLASCH & BIRCH, PO BOX 747, FALLS CHURCH, VA, 22040-0747, US

(73) Assignee: A'STRIKER ENTERPRISE CO., LTD.

(21) Appl. No.: 11/599,447

(22) Filed: Nov. 15, 2006

(51) Int. Cl. B32B 1/08

(52) U.S. Cl. 428/36.2

(57) ABSTRACT

An inner tube of balls includes a first rubber layer to form an inner layer, a fabric layer located on an outer surface of the first rubber layer, and a second rubber layer located on the fabric layer to sandwich the fabric layer between the first rubber layer and the second rubber layer. The fabric layer provides support so that the inner tube is less likely to deform after inflation, and the quality of the balls improves.

### FIELD OF THE INVENTION

The present invention relates to an inner tube of balls and particularly to an inner tube structure of balls.

### BACKGROUND OF THE INVENTION

Balls for sports that are injected and sealed with air generally are divided into two types: bonding balls and stitching balls. The bonding balls further include ones made from impermeable rubber that have a spherical hollow rubber inner tube containing compressed air injected through a gas valve. The inner tube mentioned above usually has a reinforced layer formed by winding fibers such as nylon threads at thousands of meters on the circumference to achieve desired ball quality (such as weight, size, sphericity, durability, sphericity maintainability, and strength enhancement under forces) to become stabilized. Then the reinforced layer is covered by a rubber cover layer formed by a thin sulfuric rubber layer. The rubber cover layer further is covered by an outer layer made from multiple sheets of leather. The rubber cover layer aims to form a strong bonding for the leather sheets on the ball. The leather sheets may be man-made or natural leather. The ball thus constructed can be fabricated mechanically to facilitate production (uneven weight and size is less likely to occur). Hence such a ball has higher sphericity and durability. It also is relatively inexpensive.

The stitching ball is made by bending the edges of multiple leather sheets inwards and stitching with threads to form a spherical outer layer to house an inner tube previously discussed. The leather sheets also may be man-made or natural leather. In general, it has an inner covering formed by multiple sheets of fabrics. The fabrics are coated with adhesive such as emulsified gum or glue on the inner side of the leather sheets to enhance the strength thereof.

The balls mentioned above, whether bonding balls or stitching balls, have an inner tube injected and sealed with air. The inner tube is spherical and hollow, and made from impermeable rubber to contain compressed air injected through a gas valve. Then the inner tube is covered by a layer structure as previously discussed to achieve the desired quality (weight, size, sphericity, durability, sphericity maintainability and strength). However, due to the conventional inner tube is formed from a single layer of rubber, deformation is prone to occur in the downstream fabrication process due to too much pressure of the injected compression air. The downstream fabrication process is affected, and the ball quality suffers.

### SUMMARY OF THE INVENTION

The primary object of the present invention is to provide an inner tube of balls that is less likely to deform after inflation to achieve improved sphericity in the downstream fabrication process.

The inner tube according to the invention includes a first rubber layer to form an inner layer, a fabric layer located on an outer surface of the first rubber layer, and a second rubber layer located on the fabric layer. The structure thus formed has the fabric layer sandwiched between the first rubber layer and the second rubber layer.

With the support of the fabric layer, the inner tube is less likely to deform after inflation. Compared with the conventional inner tube which does not have any support structure and tends to deform under a greater air pressure, the inner tune of the invention can achieve improved quality for the balls.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of an embodiment of the fabric core rubber sheet of the invention.

FIG. 2 is a perspective view of an embodiment of the fabric core rubber sheet of the invention.

FIG. 3 is a schematic view of an embodiment of the fabric core rubber sheet in a cutting condition.

FIG. 4 is a perspective view of an embodiment of the inner tube of the invention.

FIG. 5 is a cross section of the inner tube according to FIG. 4.

### DETAILED DESCRIPTION OF THE PREFERRED EMBODIMENT

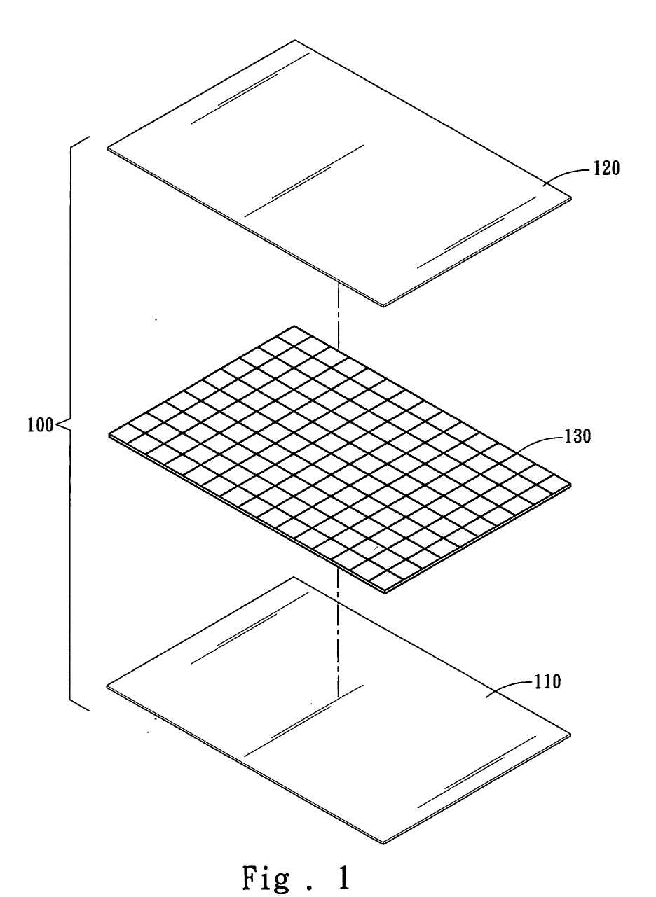

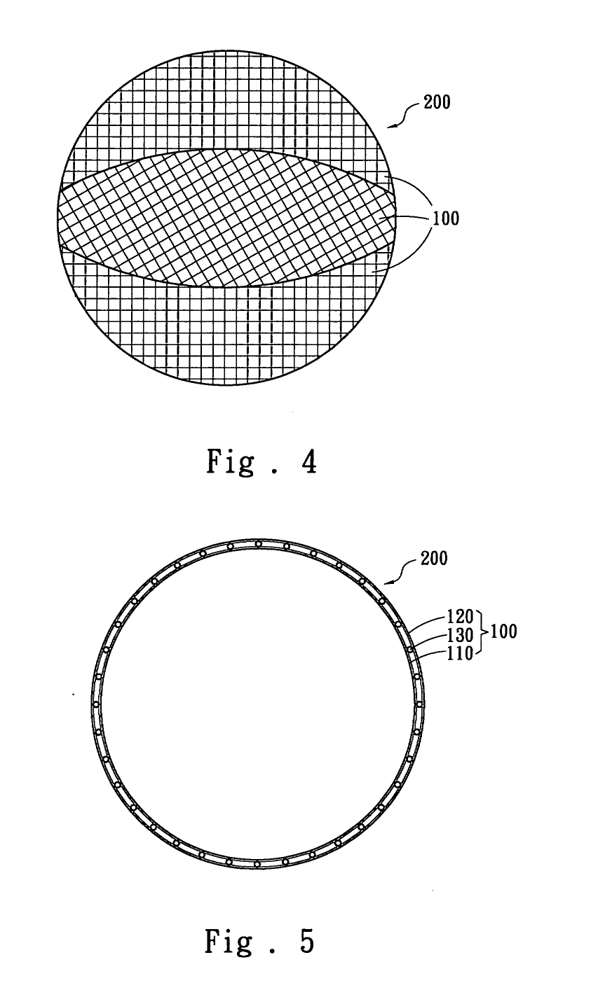

Please referring to FIGS. 1 through 5, the inner tube 200 of ball according to the invention includes a first rubber layer 110 which is an inner layer, a fabric layer 130 located on an outer surface of the first rubber layer 110, and a second rubber layer 120 located on the fabric layer 130 to sandwich the fabric layer 130 with the first rubber layer 110 (as shown in FIG. 5).

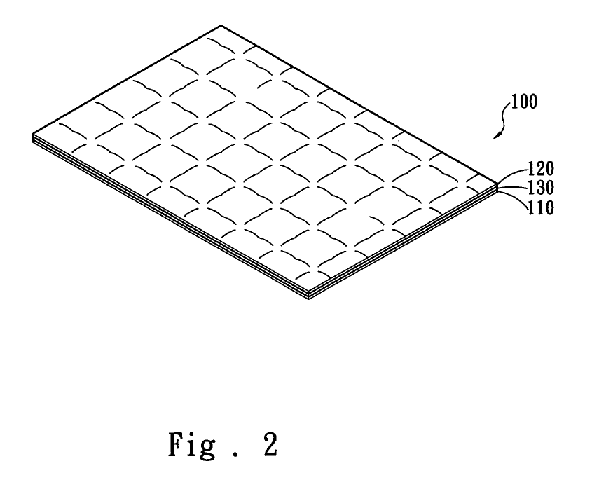

In the embodiment set forth above, the fabric layer 130 is sandwiched between the first rubber layer 110 and the second rubber layer 120 (as shown in FIG. 1) through a calender to form a fabric core rubber sheet 100 (as shown in FIG. 2).

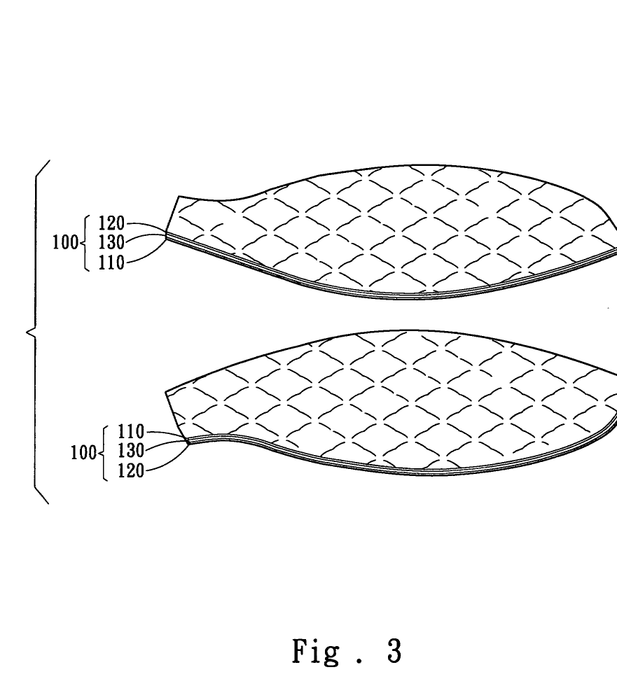

Then the fabric core rubber sheet 110 is cut to required sizes according to the needed inner tube 200 (as shown in FIG. 3). The cut fabric core rubber sheet 100 is primarily bonded through molds. Then as the conventional technique does, the primarily bonded fabric rubber sheet 100 is aged through a sulfurizing process to form the inner tube 200 that has a core fabric. (referring to FIG. 4), with the fabric layer 130 sandwiched between the first rubber layer 110 and the second rubber layer 120 (referring to FIG. 5).

As the inner tube 200 has the fabric layer 130 sandwiched between the first rubber layer 110 and the second rubber layer 120 with the fabric layer 130 serving as the core fabric, the inner tube 200 can be supported by the core fabric (fabric layer 130). Hence after inflation the inner tube 200 is less likely to deform due to air pressure. By contrast, the conventional inner tube of balls does not have any support, hence tends to deform when inflated under a great air pressure.

Moreover, to achieve desired ball quality (weight, size, sphericity, durability, sphericity maintainability, and strength) there are downstream processes after the inner tube 200 is made. This is especially true at the final fabrication stage for mechanical machine stitching (bonding) and manual stitching the leather sheets to brace the sphericity. Through the inner tube 200 of the invention, because it is less likely to deform after inflation, the leather sheets processed by machine stitching and manual stitching can form a more desirable sphericity.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. An inner tube of balls, comprising:
a first rubber layer to form an inner layer of the inner tube;
a fabric layer located on an outer surface of the first rubber layer; and
a second rubber layer located on the fabric layer to sandwich the fabric layer between the first rubber layer and the second rubber layer.
